(19) United States
(12) Patent Application Publication
(10) Pub. No.: US 2014/0189103 A1
(43) Pub. Date: Jul. 3, 2014

(54) SYSTEM FOR MONITORING SERVERS AND METHOD THEREOF

(71) Applicants: HON HAI PRECISION INDUSTRY CO., LTD., New Taipei (TW); HONG FU JIN PRECISION INDUSTRY (ShenZhen) CO., LTD., Shenzen (CN)

(72) Inventor: CAN-HUI SONG, Shenzhen (CN)

(73) Assignees: HONG FU JIN PRECISION INDUSTRY (ShenZhen) CO., LTD., Shenzhen (CN); HON HAI PRECISION INDUSTRY CO., LTD., New Taipei (TW)

(21) Appl. No.: 14/083,459

(22) Filed: Nov. 19, 2013

(30) Foreign Application Priority Data
Dec. 27, 2012 (CN) 2012105802601

(51) Int. Cl. H04L 12/26

(52) U.S. Cl. CPC H04L 43/065
USPC 709/224

(57) ABSTRACT

A system and a method for monitoring servers are presented. The system is applied on a test apparatus and a number of servers. The test apparatus communicates with the number of servers. Once the system detects an abnormal operation condition of the server, the system directly sends an abnormal report as to the abnormal operation condition of the server to the test apparatus 10, and the test apparatus outputs the an abnormal report so that the administrator debugs the server, thereby ensuring the continued normal running of the server.

### BACKGROUND

1. Technical Field

The disclosure relates to servers and, more particularly, to a system for monitoring servers and a monitoring method in relation to the servers.

2. Description of Related Art

A server stores a large amount of data. A test apparatus is provided for monitoring all servers located in a cabinet on an intelligent platform management bus (IPMB). The test apparatus looks for an abnormal condition of each server one by one in turn. However, because the data processing ability of the IPMB is limited, and the acquired information from the server is large, it will take a long time for the test apparatus to process the data, which is undesirable.

Therefore, what is needed is a system for monitoring servers to overcome the described shortcoming.

### BRIEF DESCRIPTION OF THE DRAWINGS

FIG. 1 is a schematic view of a test apparatus communicating with a number of servers to enable monitoring in accordance with an exemplary embodiment.

FIG. 2 is a schematic view of a physical connection between the test apparatus and the number of servers of FIG. 1.

FIG. 3 is a flowchart of a monitoring method applied to the test apparatus and the number of servers of FIG. 1.

### DETAILED DESCRIPTION

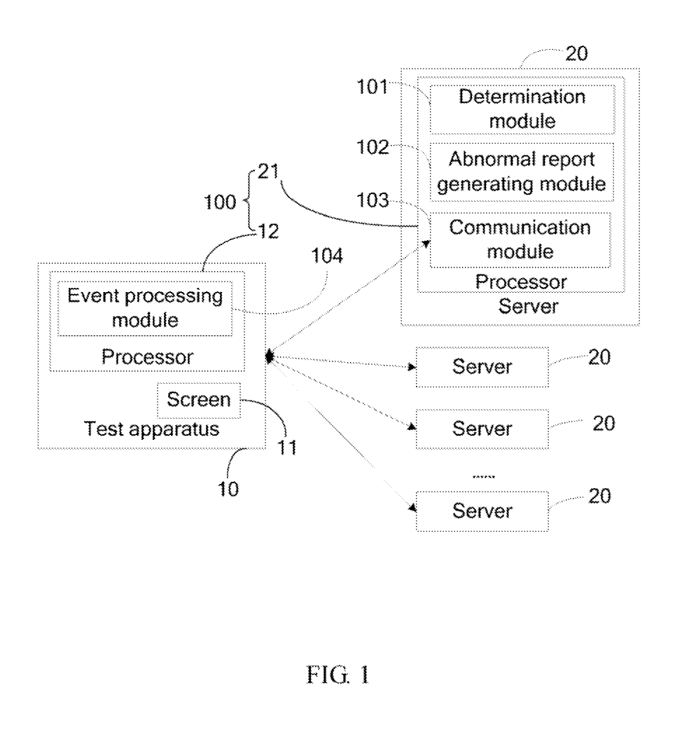

FIG. 1 is a schematic view of a test apparatus communicating with a number of servers to enable monitoring in accordance with an exemplary embodiment. A system for monitoring servers (hereinafter “the system”) 100 is applied on the test apparatus 10 and the number of servers 20. The test apparatus 10 communicates with the number of servers 20 via a wire or wireless manner. The test apparatus 10 includes a processor 12 and each of the number of the servers 20 includes a processor 21.

Each of the number of the servers 20 is assigned an identifier (ID). For example, the ID is an IP address of the server 20, or an address assigned by a dynamic host configuration protocol (DHPC) server (not shown). In another embodiment, the ID is the one of a hardware component, such as a serial number of a CPU of the server 20.

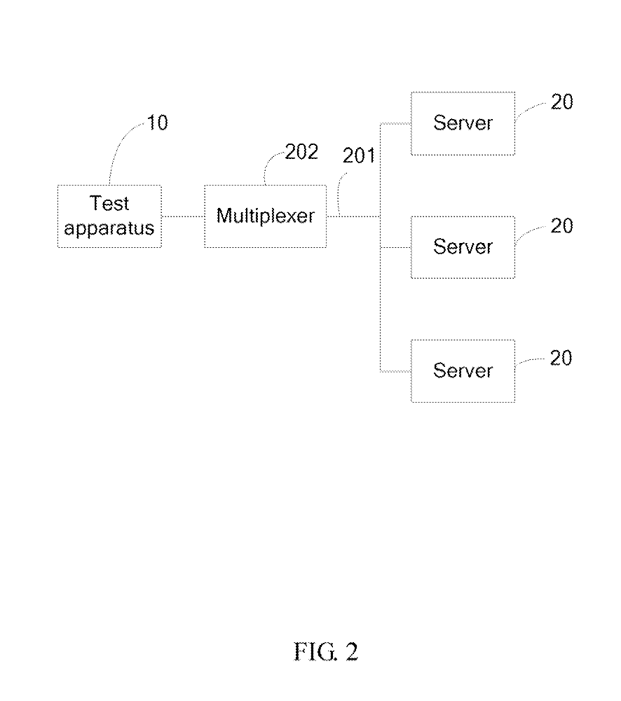

FIG. 2 shows that the test apparatus 10 is connected with a multiplexer 202 via a wired line and the multiplexer 202 is connected with the number of servers 20 via an intelligent platform management bus (IPMB) 201. The test apparatus 10 communicates with one of the number of servers 20 via a physical connection. The multiplexer 202 is configured to switch and establish a communication between the test apparatus 10 and the server 20 via the physical connection.

The system 100 includes the processor 12 and the processor 21. The processor 21 includes a determination module 101, an abnormal report generating module 102, and a communication module 103. The processor 12 includes an event processing module 104. The determination module 101, the abnormal report generating module 102, and the communication module 103 are applied on the server 20. The event processing module 104 is applied on the test apparatus 10. In another embodiment, the determination module 101, the abnormal report generating module 102, and the communication module 103 are stored in a mobile storage device (not shown), such as a mobile hard disk. When the mobile storage device is connected to the server 20, the determination module 101, the abnormal report generating module 102, and the communication module 103 are applied on the server 20 and monitor the running of the server 20. The test apparatus 10 further includes a screen which displays information.

The determination module 101 monitors aspects of the running of each server 20 in real time. For example, the determination module 101 monitors the server 20 in response to user input from the server 20 or the test apparatus 10. When the determination module 101 detects an abnormal operation condition of the server 20, the abnormal report generating module 102 generates an abnormal report of the detected server 20. The abnormal report includes the ID of the detected server 20 and information as to the abnormal operation condition of the detected server 20. For example, an abnormal operation condition may include a too-high temperature of a CPU of the server 20. Such information reflects the running information of the server 20.

The communication module 103 sends the abnormal report of the server 20 to the event processing module 104. For a simple description, an abnormal operation condition of the server 20 is defined as an event. In the embodiment, the communication module 103 sends the abnormal report of the server 20 via a simple network management protocol (SNMP) trap manner, that is, the communication module 103 positively sends the abnormal report of the server 20 to the event processing module 104.

The event processing module 104 receives the abnormal report of the server 20 and collects the abnormal report of the server 20 in an event list. Furthermore, the event processing module 104 controls to output the abnormal report of the server 20. In the embodiment, the event processing module 104 controls the screen 11 to display the abnormal report of the server 20. Therefore, when an administrator looks at the abnormal report of the server 20 on the screen 11, the administrator can debug the server 20 based on the abnormal report of the server 20.

The event processing module 104 further acquires the ID of the server 20 from the abnormal report and controls the multiplexer 202 to switch and establish a communication between the test apparatus 10 and the server 20 via a physical connection based on the ID. Therefore, when a debugging instruction is generated from the test apparatus 10 in response to user input from the administrator, the event processing module 104 transmits the debugging instruction to the server 20 via the physical connection to debug the server 20. For example, when the determination module 101 detects that a rotation speed of fans of the server 20 is slow, a debugging instruction of turning up the rotation speed of fans is input by the administrator to the test apparatus 10, the event processing module 104 transmits the debugging instruction to the server 20 via the physical connection to turn up the rotation speed of fans of the server 20.

Therefore, once the system 100 detects an abnormal operation condition of the server 20, the system 100 directly sends the abnormal report as to the abnormal operation condition of the server 20 to the test apparatus 10, and the test apparatus 10 outputs the abnormal report so that the administrator can debug the server 20 in real time, thus to ensuring the normal running of the server 20.

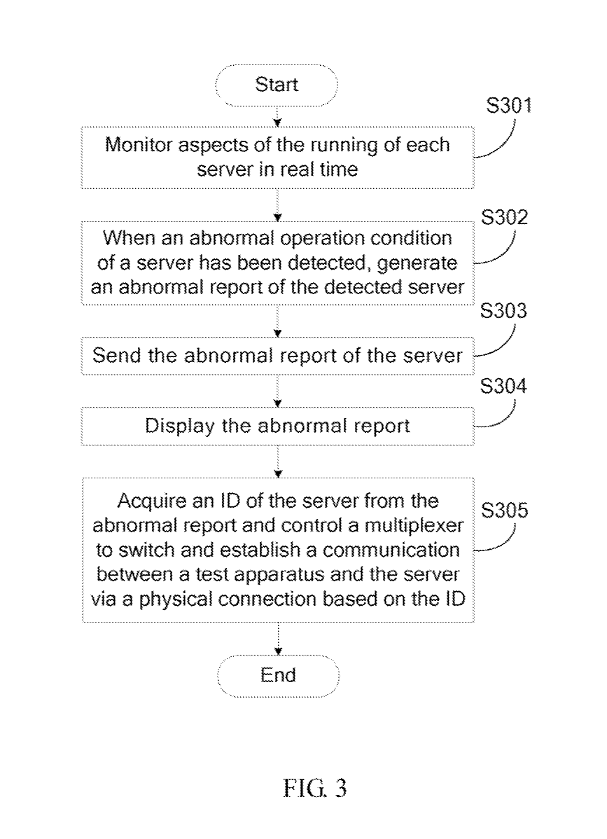

FIG. 3 is a flowchart of a monitoring method applied to the test apparatus and the number of servers of FIG. 1. In step S301, the determination module 101 monitors aspects of the running of each server 20 in real time. In step S302, when an abnormal operation condition of a server 20 has been detected, the abnormal report generating module 102 generates an abnormal report of the detected server 20. In step S303, the communication module 103 sends the abnormal report of the server 20 to the event processing module 104. In step S304, the event processing module 104 controls the screen 11 to display the abnormal report. In step S305, the event processing module 104 acquires an ID of the server 20 from the abnormal report and controls the multiplexer 202 to switch and establish a communication between the test apparatus 10 and the server 20 via a physical connection based on the ID.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A system for monitoring servers, wherein the system is applied on a test apparatus and a plurality of servers, and the test apparatus communicates with the plurality of servers, the system comprising:
one or more processors; and
a plurality of modules to be executed by the one or more processors, the modules comprising:
a determination module to monitor aspects of the running of each of the plurality of the servers in real time;
an abnormal report generating module to generate an abnormal report when the determination module detects an abnormal operation condition of one of the plurality of servers;
an event processing module to receive the abnormal report of the server and control to output the abnormal report of the server; and
a communication module to send the abnormal report of the server to the test apparatus.

2. The system for monitoring servers as recited in claim 1, wherein each of the plurality of servers is assigned an identifier, and the abnormal report comprises the identifier of the server and information as to the abnormal operation condition of the server.

3. The system for monitoring servers as recited in claim 2, wherein the identifier is an IP address of the server, or an address assigned by a dynamic host configuration protocol server, or a serial number of a CPU of the server.

4. The system for monitoring servers as recited in claim 2, wherein the test apparatus is connected with a multiplexer via a wired line and the multiplexer is connected with the plurality of servers via an intelligent platform management bus, the test apparatus communicates with one of the plurality of servers via a physical connection each time, the multiplexer is configured to switch and establish a communication between the test apparatus and the server via the physical connection.

5. The system for monitoring servers as recited in claim 4, wherein the event processing module further acquires the identifier of the server from the abnormal report and controls the multiplexer to switch and establish a communication between the test apparatus and the server via a physical connection based on the identifier.

6. The system for monitoring servers as recited in claim 1, wherein the communication module sends the abnormal report of the server via a simple network management protocol trap manner.

7. A method for monitoring servers, wherein the method is applied on a test apparatus and a plurality of servers, the test apparatus communicates with the plurality of servers, the method comprising:
monitoring aspects of the running of each of the plurality of the servers in real time;
when detecting an abnormal operation condition of one of the plurality of servers, generating an abnormal report of the server;
receiving the abnormal report of the server and outputting the abnormal report of the server; and
sending the abnormal report of the server to the test apparatus.

8. The method for monitoring servers as recited in claim 7, wherein each of the plurality of servers is assigned an identifier, and the abnormal report comprises the identifier of the server and information as to the abnormal operation condition of the server.

9. The method for monitoring servers as recited in claim 8, wherein the identifier is an IP address of the server, or an address assigned by a dynamic host configuration protocol server, or a serial number of a CPU of the server.

10. The method for monitoring servers as recited in claim 8, wherein the test apparatus is connected with a multiplexer via a wired line and the multiplexer is connected with the plurality of servers via an intelligent platform management bus, the test apparatus communicates with one of the plurality of servers via a physical connection each time, the multiplexer is configured to switch and establish a communication between the test apparatus and the server via the physical connection.

11. The method for monitoring servers as recited in claim 10, further comprising:
acquiring the identifier of the server from the abnormal report and controlling the multiplexer to switch and establish a communication between the test apparatus and the server via a physical connection based on the identifier.

12. The method for monitoring servers as recited in claim 7, the step “sending the abnormal report of the server to the test apparatus” comprising: sending the abnormal report of the server via a simple network management protocol trap manner.

13. A computer-readable storage medium encoded with a computer program, the program comprising instructions that when executed by one or more computers cause the one or more computers to perform operations for monitoring servers, wherein the operations are applied on a test apparatus and a plurality of servers, the test apparatus communicates with the plurality of servers, the operations comprising:
monitoring aspects of the running of each of the plurality of the servers in real time;
when detecting an abnormal operation condition of one of the plurality of servers, generating an abnormal report of the server;
receiving the abnormal report of the server and outputting the abnormal report of the server; and
sending the abnormal report of the server to the test apparatus.

14. The computer-readable storage medium encoded with a computer program as recited in claim 13, wherein each of the plurality of servers is assigned an identifier, and the abnormal report comprises the identifier of the server and information as to the abnormal operation condition of the server.

15. The computer-readable storage medium encoded with a computer program as recited in claim 14, wherein the identifier is an IP address of the server, or an address assigned by a dynamic host configuration protocol server, or a serial number of a CPU of the server.

16. The computer-readable storage medium encoded with a computer program as recited in claim 14, wherein the test apparatus is connected with a multiplexer via a wired line and the multiplexer is connected with the plurality of servers via an intelligent platform management bus, the test apparatus communicates with one of the plurality of servers via a physical connection each time, the multiplexer is configured to switch and establish a communication between the test apparatus and the server via the physical connection.

17. The computer-readable storage medium encoded with a computer program as recited in claim 16, the operations further comprising:
acquiring the identifier of the server from the abnormal report and controlling the multiplexer to switch and establish a communication between the test apparatus and the server via a physical connection based on the identifier.

18. The computer-readable storage medium encoded with a computer program as recited in claim 13, the operations “sending the abnormal report of the server to the test apparatus” comprising:
sending the abnormal report of the server via a simple network management protocol trap manner.
